(19) United States
(12) Patent Application Publication
(10) Pub. No.: US 2022/0398271 A1
(43) Pub. Date: Dec. 15, 2022

(54) COMPUTING SYSTEM FOR EXTRACTING FACTS FOR A KNOWLEDGE GRAPH

(71) Applicant: Microsoft Technology Licensing, LLC, Redmond, WA (US)

(72) Inventors: Ling WU, Bothell, WA (US); Yiran FEI, Issaquah, WA (US); Minghui XIA, Sammamish, WA (US); Yi LI, Bellevue, WA (US)

(21) Appl. No.: 17/347,761

(22) Filed: Jun. 15, 2021

(51) Int. Cl. G06F 16/332; G06F 16/957; G06F 40/295; G06N 5/02

(52) U.S. Cl. CPC G06F 16/3329; G06F 16/9574; G06F 40/295; G06N 5/022

(57) ABSTRACT

A computing system generates a query that references an entity based upon an ontology of a knowledge graph and a query pattern and identifies at least one passage from amongst a plurality of passages stored in a passage repository based upon the query and at least one ranking model. The computing system identifies potential answers to the query based upon the at least one passage, the query, and a machine reading comprehension model. The computing system suppresses invalid answers in the potential answers to the query using a plurality of computer-implemented techniques, thereby identifying an answer to the query. The computing system generates a fact for the entity based upon the answer and the ontology and adds the fact to the knowledge graph such that the fact is linked to the entity in the knowledge graph, where the fact is available for querying.

### BACKGROUND

A knowledge graph is a computer-implemented data structure that relates entities (e.g., persons, places, things, and/or events) to facts about the entities, where a fact about an entity in the knowledge graph is represented by at least two nodes that are connected by at least one edge. In a specific example, a knowledge graph includes an entry for an actor and facts about the actor, such as height, weight, movies acted in, and so forth. Knowledge graphs have applications in a variety of areas, including natural language processing (NLP), search engines, and social networks.

The utility of a knowledge graph is dependent upon the accuracy and completeness of the facts included in the knowledge graph. Conventionally, facts are extracted from data (e.g., structured data, semi-structured data, or unstructured data) and added to the knowledge graph using rule-based approaches. However, rule-based approaches are limited by a number of rules employed to extract the data and do not scale well, especially when extracting facts from unstructured data. Facts may also be added to a knowledge graph manually by a user; however, this approach is cumbersome and prone to error.

### SUMMARY

The following is a brief summary of subject matter that is described in greater detail herein. This summary is not intended to be limiting as to the scope of the claims.

Described herein are various technologies pertaining to adding facts to a knowledge graph. In an example, a computing system generates a query that references an entity based upon an ontology of a knowledge graph and a query pattern. The computing system identifies at least one passage from amongst a plurality of passages based upon the query and at least one ranking model. The computing system identifies potential answers to the query in the at least one passage based upon the at least one passage, the query, and a machine reading comprehension (MRC) model. The computing system suppresses invalid answers in the potential answers using a plurality of computer-implemented techniques in order to identify an answer to the query. The computing system generates a fact for the entity based upon the answer and the ontology and adds the fact to the knowledge graph, where the fact is then available for querying.

In operation, an ontology specifies predicates (also referred to as properties) that are to be associated with an entity (e.g., a person, place, thing, event, or idea) referenced in a knowledge graph based upon a type of the entity. In an example where the entity is a person, the ontology specifies that predicates such as height, weight, and date of birth of the person are to be included in the knowledge graph. In another example where the entity is an athlete, the ontology specifies that predicates such as sport played, team associations, and salary (as well as predicates for a person such as height, weight, and date of birth) are to be included in the knowledge graph.

The computing system may identify that a fact for an entity is missing in the knowledge graph. In an example, the missing fact is a date of birth of an athlete. The computing system generates a query that references the entity based upon the ontology and a query pattern, where the query pattern has been extracted from query logs (e.g., search engine logs). In an example, the query is “What is the athlete's date of birth?” The computing system may execute a search over a plurality of passages based upon the query to identify potentially relevant passages. The computing system identifies at least one passage based upon the query and at least one ranking model. According to embodiments, the at least one ranking model includes a recall ranking model and a precision ranking model. The computing system identifies potential answers to the query in the at least one passage based upon content (e.g., text) of the at least one passage, the query, and a machine reading comprehension (MRC) model.

The computing system suppresses invalid answers in the potential answers to the query using a plurality of computer-implemented techniques, thereby identifying an answer to the query. Such techniques include one or more of natural language processing techniques (e.g., part of speech (POS) analysis, dependency tree analysis, regular expression matching), normalization to knowledge graph supported formats, and entity linking between entities referenced in passages and entities referenced in queries. The computing system generates a fact based upon the answer. According to embodiments, the fact is a triple in the form of subject-predicate-object, where the subject is the entity, the object is the answer, and the predicate is a relationship between the entity and the answer that is specified by the ontology. The computing system performs a consistency check between the fact and other facts for the entity in the knowledge graph to ensure that the fact is consistent with the other facts for the entity. The computing system checks that the fact is consistent with the at least one passage using a deep learning model and adds the fact to the knowledge graph upon determining that the fact is consistent, where the fact linked to the entity in the knowledge graph. When the knowledge graph is queried with a user query that references the entity, the fact is returned to a computing device of a user.

The above-described technologies present various advantages over conventional approaches to extracting facts from data that are to be added to a knowledge graph. First, unlike conventional approaches, the above-described technologies utilize a combination of rankers, deep learning models, and natural language processing (NLP) techniques to extract facts from data. This tends to lead to the extraction of higher quality (e.g., more accurate) facts from the data than conventional approaches. Second, unlike conventional approaches, the above-described technologies are not limited by a finite number of rules and scale well across diverse sets of data, including unstructured data, such as unstructured text on a web page. Third, unlike some conventional approaches, the above-described technologies do not require manual input on behalf of a user to add facts to the knowledge graph.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an example computing system that facilitates delivering facts obtained from a knowledge graph to users.

FIG. 2 is an example knowledge graph.

FIG. 3 is a functional block diagram of an example computing system that facilitates adding facts to a knowledge graph.

FIG. 4 is a functional block diagram of an example suppressor that prevents invalid facts from being added to a knowledge graph.

FIG. 5 is a high-level overview of an example process of adding facts to a knowledge graph.

FIG. 6 is a functional block diagram of an example computing system that facilitates delivering facts obtained from a knowledge graph as part of a search engine results page that is presented to a user.

FIG. 7 is an example illustration of an example search engine results page that includes facts obtained from a knowledge graph.

FIG. 8 is a functional block diagram of an example computing system that facilitates delivering facts obtained from a knowledge graph to a user via an intelligent virtual assistant.

FIG. 9 is a flow diagram that illustrates an example methodology performed by a computing system for adding facts to a knowledge graph.

FIG. 10 is a flow diagram that illustrates an example methodology performed by a computing device operated by a user for presenting a newly added fact in a knowledge graph to the user.

FIG. 11 is an example computing device.

Various technologies pertaining to adding new facts to a knowledge graph are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

### DETAILED DESCRIPTION

As described above, conventionally, rule-based approaches are utilized to extract facts from data that are subsequently added to a knowledge graph. However, such rule-based approaches are limited by a number of rules and do not scale well, especially when applied to unstructured data. While some conventional approaches may utilize conventional machine learning approaches in combination with rule-based approaches, such approaches are still limited by the rules. To address deficiencies of conventional approaches, a computing system is described herein that is configured to extract facts from a data source (e.g., unstructured text) and add the facts to a knowledge graph using a combination of rankers, deep learning models, natural language processing (NLP) techniques, normalization, entity linking and/or inconsistency checks, where the knowledge graph may then be queried for the facts.

Briefly, an ontology of a knowledge graph specifies predicates (also referred to as properties) that are to be included in a knowledge graph for an entity (e.g., a person, place, thing, event, or idea) based upon a type of the entity. Nodes in the knowledge graph represent entities or attributes and edges connecting the nodes represent relationships between the entities or relationships between the entities and the attributes, where the relationships are specified by the ontology based upon types of the entities. In an example where the entity is a politician, the ontology may specify that a date of death of the politician is to be included in the knowledge graph (if the politician is deceased). According to embodiments, facts are expressed in a triple form of subject-predicate-object, where the subject is the entity (e.g., a politician), the predicate is a relationship (e.g., a date of birth), and the object is either an attribute of the entity (e.g., 10/20/20) or another entity, and where the ontology specifies the predicate based upon the type of type of the entity.

A fact about an entity may be missing in the knowledge graph. In an example, the fact is a date of birth of a politician. To address the missing fact, the computing system generates a query that references the entity based upon the ontology and a query pattern, where the query pattern has been extracted from query logs (e.g., search engine logs). In an example, the query is “What is the politician's date of birth?” The computing system may execute a search over a plurality of passages based upon the query to identify potentially relevant passages. The computing system identifies at least one passage based upon the query and at least one ranking model. According to embodiments, the at least one ranking model includes a recall ranking model and a precision ranking model. The computing system identifies potential answers to the query in the at least one passage based upon content (e.g., text) of the at least one passage, the query, and a machine reading comprehension (MRC) model.

The computing system suppresses invalid answers in the potential answers to the query using a plurality of computer-implemented techniques, thereby identifying an answer to the query. Such techniques may include one or more of natural language processing techniques (e.g., part of speech (POS) analysis, dependency tree analysis, regular expression matching), normalization to knowledge graph supported formats, and/or entity linking between entities referenced in passages and entities referenced in queries. The computing system generates a fact based upon the answer and the ontology. According to embodiments, the fact is expressed in the triple form of subject-predicate-object. The computing system performs a consistency check between the fact and other facts for the entity in the knowledge graph to ensure that the fact is consistent with the other facts for the entity. The computing system checks that the fact is consistent with the at least one passage using a deep learning model and adds the fact to the knowledge graph upon determining that the fact is consistent, where the fact is linked to the entity in the knowledge graph. When the knowledge graph is queried with a user query that references the entity, the fact is returned to a computing device of a user. According to embodiments, the fact is presented concurrently with uniform resource locators (URLs) displayed on a search engine results page.

The above-described technologies present various advantages over conventional approaches to extracting facts from data that are to be added to a knowledge graph. First, unlike conventional approaches, the above-described technologies utilize a combination of rankers, deep learning models, and natural language processing (NLP) techniques to extract facts from data. This tends to lead to the extraction of higher quality (e.g., more accurate) facts from the data than conventional approaches. Second, unlike conventional approaches, the above-described technologies are not limited by a finite number of rules and scale well across diverse sets of data, including unstructured data. Third, unlike some conventional approaches, the above-described technologies do not require manual input on behalf of a user to add facts to the knowledge graph.

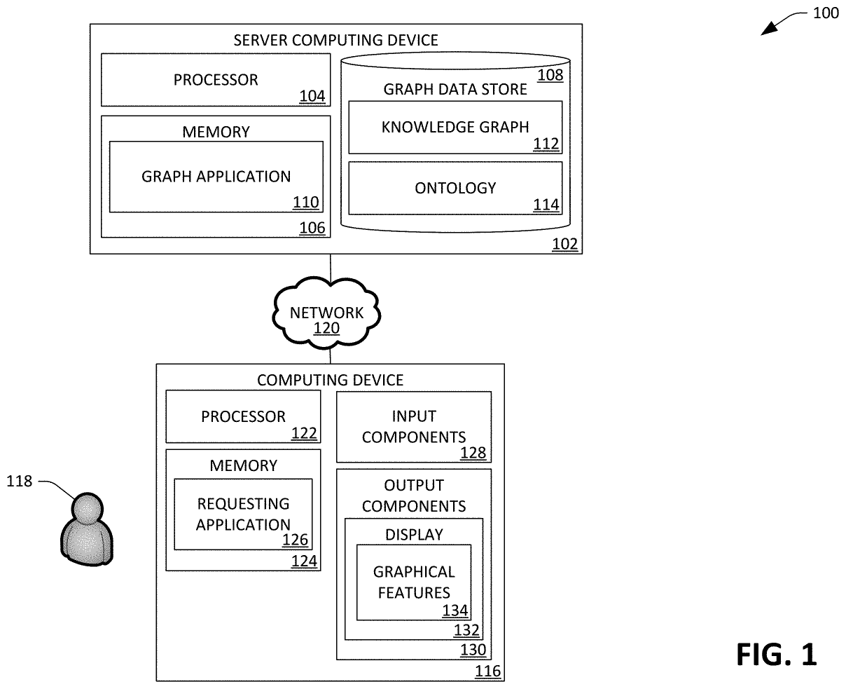

With reference to FIG. 1, an example computing system 100 that facilitates delivering facts obtained from a knowledge graph to users is illustrated. The computing system 100 includes a server computing device 102. According to embodiments, the server computing device 102 is a cloud-based computing device. The server computing device 102 includes a processor 104, memory 106, and a graph data store 108. The memory 106 has a graph application 110 loaded therein. The graph application 110, when executed by the processor 104, is generally configured to query a knowledge graph 112 stored in the graph data store 108 for facts that are stored in the knowledge graph 112 and return such facts to devices of users. The knowledge graph 112 may be a general knowledge graph or the knowledge graph 112 may be a domain-specific knowledge graph. In an example, the knowledge graph 112 is an organization-specific knowledge graph that stores facts about an organization, such as information about members of the organization. The knowledge graph 112 includes nodes and edges connecting the nodes. A node in the knowledge graph 112 represents an entity or an attribute. Entities represented in the knowledge graph 112 may be persons, places, things, events, and/or ideas. According to embodiments, entities represented in the knowledge graph 112 are nouns. Attributes represented in the knowledge graph 112 describe the entities represented in the knowledge graph 112. Attributes represented in the knowledge graph 112 may be strings, numbers, dates, etc. According to embodiments, the attributes represented in the knowledge graph 112 are objects of the nouns. An edge in the knowledge graph 112 represents a relationship between two different entities represented by nodes in the knowledge graph 112 or a relationship between an entity represented by a node in the knowledge graph 112 and an attribute represented by another node in the knowledge graph 112. Two nodes that are connected by an edge in the knowledge graph 112 represent a fact about an entity. The graph application 110 may also be configured to add, modify, or delete nodes in the knowledge graph 112 in order to add, modify, or delete facts about entities in the knowledge graph 112.

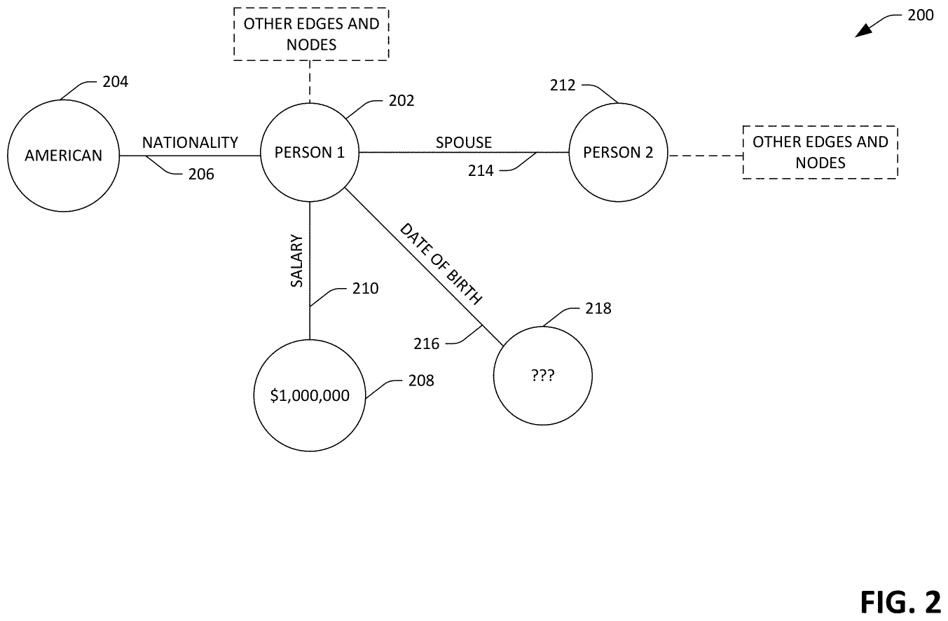

Turning now to FIG. 2, an example knowledge graph 200 is depicted. The knowledge graph 200 may be or include the knowledge graph 112 or the knowledge graph 112 may be or include the knowledge graph 200. The knowledge graph 200 includes a first node 202 that represents a first person (e.g., an entity, such as an actor, an athlete, etc.). The first node 202 is connected to a second node 204 in the knowledge graph 200, where the second node 204 represents “American” (an attribute). The first node 202 and the second node 204 are connected via a first edge 206 in the knowledge graph 200, where the first edge 206 has “Nationality” criteria assigned thereto. Thus, the first node 202, the second node 204, and the first edge 206 represent a first fact about the first person: The first person is of American Nationality. The knowledge graph 200 includes a third node 208 that is connected to the first node 202 by a second edge 210. The third node 208 represents $1,000,000 (an attribute) and the second edge 210 has “Salary” criteria assigned thereto. Thus, the first node 202, the third node 208, and the second edge 210 represent a second fact about the first person: The first person has a salary of $1,000,000.

The knowledge graph 200 includes a fourth node 212 that is connected to the first node 202 by a third edge 214. The fourth node 212 represents a second person (another entity) and the third edge 214 has “Spouse” criteria assigned thereto. Thus, the first node 202, the fourth node 212, and the third edge 214 represent a third fact about the first person: The first person is married to the second person. As the first node 202 and the fourth node 212 represent entities, it is to be understood that the first node 202 and the fourth node 212 may be connected to many other nodes (representing many other entities or attributes) via many other edges (representing many other relationships).

It is to be understood that the knowledge graph 200 may be incomplete, that is, certain facts about entities represented in the knowledge graph 200 may be missing from the knowledge graph 200. In an example, the knowledge graph 200 includes a fourth edge 216 that is assigned date of birth criteria, but the date of birth of the first person 202 is not currently known and as such is not included in the knowledge graph 200 (indicated in FIG. 2 by a fifth node 218 that has “???” inscribed herein).

Turning back to FIG. 1, the graph data store 108 may store an ontology 114. The ontology 114 defines possible types of entities, possible types of relationships between entities, and possible types of relationships between entities and attributes in the knowledge graph 112. According to embodiments, the ontology 114 specifies a predicate (also referred to as a property) for an entity based on a type of the entity and a fact is expressed as a subject-predicate-object triple, where the subject is an entity, where the predicate is a relationship, and where the object is either a second entity or an attribute. The subject may be a unique identifier for the entity and the object may be a unique identifier for a second entity. As such, according to embodiments, the subject corresponds to a first node in the knowledge graph 112, the predicate corresponds to criteria assigned to an edge in the knowledge graph 112 that is indicative of a relationship, and the object corresponds to a second node in the knowledge graph 112, where the edge connects the first node and the second node.

The computing system 100 further includes a computing device 116 that is operated by a user 118. According to embodiments, the computing device 116 is a desktop computing device, a laptop computing device, a tablet computing device, or a smartphone. The computing device 116 is in communication with the server computing device 102 by way of a network 120 (e.g., the Internet, intranet, etc.). The computing device 116 includes a processor 122 and memory 124, where the memory 124 has a requesting application 126 loaded therein. The requesting application 126, when executed by the processor 122, is generally configured to transmit requests for facts pertaining to an entity referenced in the knowledge graph 112 to the graph application 110. The requesting application 126 is also configured to present (e.g., visually present, audibly present, etc.) the facts obtained from the knowledge graph 112 to the user 118. According to embodiments, the requesting application 126 is a web-based application such as a search engine, an intelligent virtual assistant, and/or an application dedicated to querying the knowledge graph 112. The computing device 116 includes input components 128 that enable the user 118 to set forth input to the computing device 116. The input components 128 may include a mouse, a keyboard, a touchscreen, a track pad, a scroll wheel, a camera, a video camera, and/or a microphone. The computing device 116 further includes output components 130 that are configured to present data in various forms to the user 118. The output components 130 may include a display 132, where graphical features 134 may be presented thereon. In an example, the graphical features 134 include a graphical user interface (GUI) for the requesting application 126. The output components 130 may also include a speaker and/or a haptic feedback device (not shown in FIG. 1).

When an entity is added to the knowledge graph 112, the graph application 110 obtains (e.g., determines automatically or receives as manual input from a user) a type (e.g., a person) for the entity based upon the ontology 114. The ontology 114 specifies predicates for the entity based upon the type of the entity, where facts that include the predicates are to be added to the knowledge graph 112 and linked to the entity. In an example, the ontology 114 specifies for an entity of the type “person”, the knowledge graph 112 should include a height of the person, a weight of the person, a date of birth of the person, and so forth. The graph application 110 may obtain some of the facts for the entity as manual input from a user. The graph application 110 may also automatically determine some of the facts via mining of structured (e.g., data in a relational database) or semi-structured (e.g., data in an Extensible Markup Language (XML) file) data sources. However, certain facts for the person entity may be missing. In an example, the certain facts are included in an unstructured (e.g., free-form text in a web page) data source.

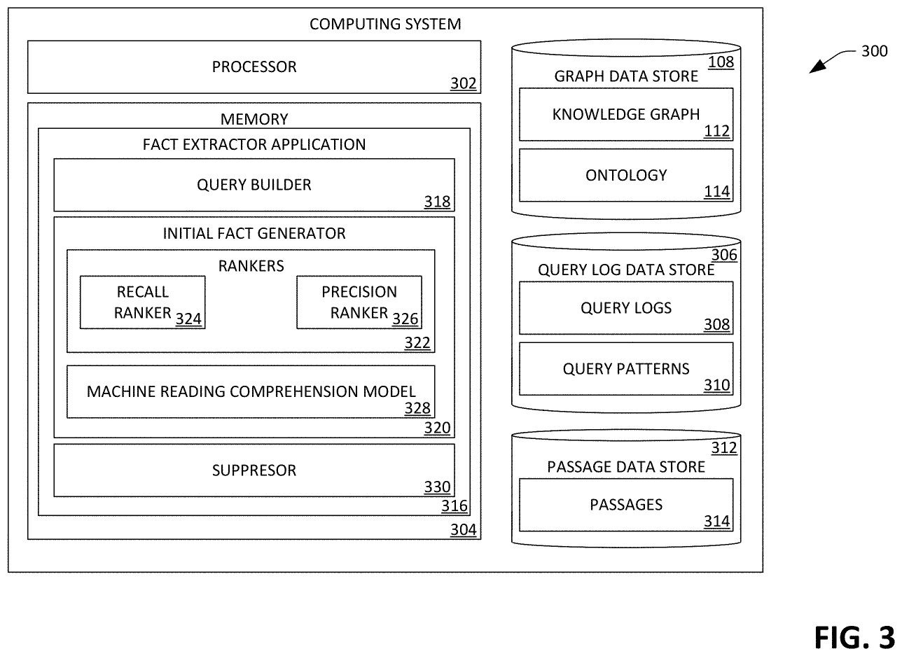

Referring now to FIG. 3, a functional block diagram of an example computing system 300 that facilitates adding facts to the knowledge graph 112 is illustrated. In an example, the computing system 300 may be or include the server computing device 102 or the server computing device 102 may be or include the computing system 300. According to embodiments, the computing system 300 is a cloud-based computing device.

The computing system 300 includes a processor 302, memory 304, and a query log data store 306. The query log data store 306 stores query logs 308 for queries. According to embodiments, the query logs 308 are for queries that have been submitted to a search engine. According to embodiments, the query logs 308 are for queries that have been submitted to the graph application 110. An example query log in the query logs 308 includes a query, where the query references an entity that has been searched. The query may also include one or more search terms. The example query log may also include a datetime of the query and an identifier for a geographic region in which the query originated. In a specific example, the query log may include a “What is Person 1's date of birth” query, where “Person 1” is the entity and “What is . . . date of birth” are the one or more additional search terms. The query log data store 306 also stores query patterns 310 that have been mined from the query logs 308 using pattern mining techniques. According to embodiments, the query patterns 310 are based upon types of entities referenced in the query logs 308. In an example, for an entity type of person, a query pattern may be “What is <person's> date of birth” or “How tall is <person>?”, where “< >” indicates a generic placeholder for the type of the entity and where the generic placeholder is replaced by an identifier for a specific entity (e.g., “What is Person 1's date of birth?”, “How tall is Person 1?”, etc.). The query patterns 310 enable queries to be generated for an entity, even when the query logs 308 do not specifically include a particular query. In an example, the query logs 308 may not include a query of “What is Athlete 1's date of birth?”; however, as Athlete 1 is a person and a pattern of “What is <person's> date of birth?” exists for persons in the query patterns 1310, a query of “What is Athlete 1's date of birth?” may be generated.

The computing system 300 also includes a passage data store 312 (also referred to as “the passage repository 312”). The passage data store 312 stores a plurality of passages 314. The plurality of passages 314 include unstructured computer-readable text. It is contemplated that the plurality of passages 314 reference entities and attributes of the entities. According to embodiments, the plurality of passages 314 include web pages available on the Internet. It is further contemplated that the plurality of passages 314 may include thousands of passages, millions of passages, billions of passages, etc. The computing system 300 also includes the graph data store 108 that stores the knowledge graph 112 and the ontology 114 described above.

Although the graph data store 108, the query log data store 306, and the passage data store 312 have been described above as being included in the computing system 300, it is to be understood that such data stores may be located on different computing devices and may be external to the computing system 300. Furthermore, according to embodiments, the knowledge graph 112, the ontology 114, the query logs 308, the query patterns 310, and the passages 314 are retained in one data store.

The memory 304 has a fact extractor application 316 (also referred to herein as “the fact extractor 316”) loaded therein. The fact extractor 316, when executed by the processor 302, is generally configured to identify a fact for an entity from the plurality of passages 314 and to add the fact to the knowledge graph 112 such that the fact is linked to the entity in the knowledge graph 112, where the fact was initially missing from the knowledge graph 112. According to embodiments, the fact extractor 316 is also configured to verify that existing facts for the entity in the knowledge graph 112 are correct facts for the entity.

The fact extractor 316 includes a query builder 318. The query builder 318 is configured to generate queries for an entity (e.g., an entity referenced in the knowledge graph 112) based upon the ontology 114 of the knowledge graph 112 and the query patterns 310 (described in greater detail below). According to embodiments, each generated query for an entity leads to a single fact for the entity being identified and added to the knowledge graph 112.

The fact extractor 316 further includes an initial fact generator 320. The initial fact generator 320 is configured to generate potential answers to a query generated by the query builder 318, where the potential answers are found in unstructured text of the plurality of passages 314. The initial factor generator 320 includes rankers 322. The rankers 322 include a recall ranker 324 (also referred to as “the recall passage ranking model 324” or “the L2 ranker 324”) and a precision ranker 326 (also referred to as “the precision ranking model 326” or “the L4 ranker 326”). The recall ranker 324 is configured to rank passages in the plurality of passages 314 for relevance based upon a (generated) query and criteria that emphasizes recall, where the fact extractor 316 selects a first subset of the plurality of passages 314 based upon rankings assigned by the recall ranker 324. According to embodiments, the first subset ranges from 20-60 passages. The precision ranker 326 is configured to rank passages in the plurality of passages 314 for relevance based upon the (generated) query and criteria that emphasizes precision, where fact extractor 316 selects a second subset of the plurality of passages 314 based upon rankings assigned by the precision ranker 326, where a number of passages in the second subset is less than a number of passages in the first subset. According to embodiments, the second subset ranges from 1-5 passages. According to embodiments, the precision ranker 326 re-ranks each of the first subset of passages identified by the recall ranker 324 and fact extractor 316 selects a highest ranked passage in the (re-ranked) first subset or passages in the (re-ranked) first subset that are ranked above a threshold (e.g., the top five re-ranked passages).

According to embodiments, criteria used by the rankers 322 to rank passages include a number of times a passage has been accessed, a number of references in the passage to other passages, a number of references in the other passages to the passage, a number of times the entity is referenced in the passage, a number of times query terms in the query appear in the passage, manually set forth relevance scores, and so forth.

The initial fact generator 320 further includes a machine reading comprehension (MRC) model 328. The MRC model 328 is configured to identify one or more potential answers to a query generated by the query builder 318 in one or more passages identified by the rankers 322. According to embodiments, the MRC model 328 is a deep learning model that includes an input layer, one or more hidden layers, and an output layer, where the one or more hidden layers include edges that have learned weights assigned thereto.

The initial fact generator 320 may generate many potential answers to a query generated by the query builder 318. As such, the fact extractor 316 also includes a suppressor 330. The suppressor 330 is configured to suppress (e.g., remove) invalid answers from amongst the potential answers generated by the initial fact generator 320 such that only a valid (e.g., correct) answer to the query remains so that the fact extractor 316 can add a fact that includes the answer to the knowledge graph 112.

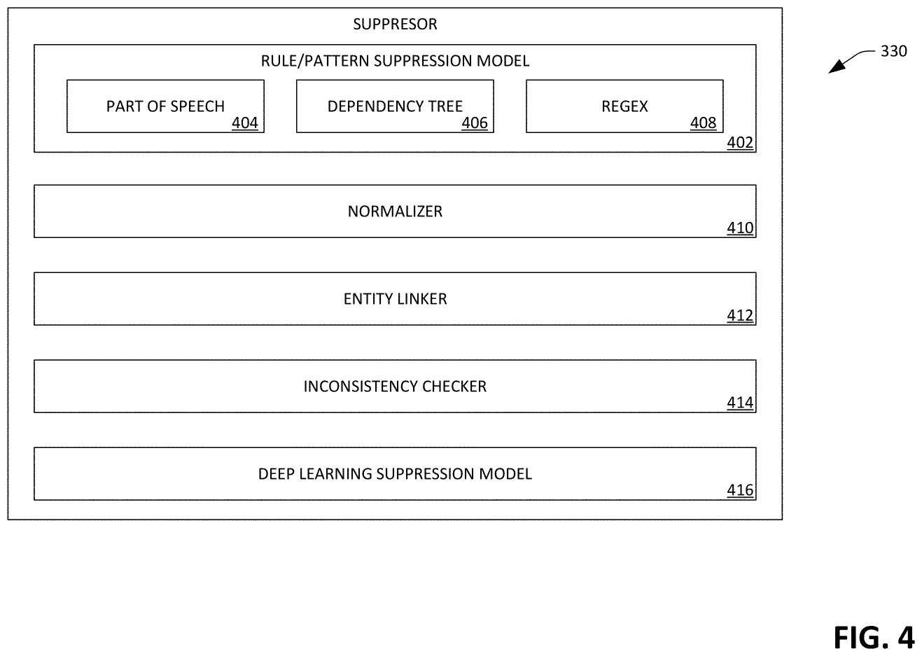

With reference now to FIG. 4, a functional block diagram of the suppressor 330 is illustrated. The suppressor 330 includes a rule/pattern suppression model 402 (also referred to as a first layer). The rule/pattern suppression model 402 is generally configured to suppress invalid answers to a query generated by the query builder 318 using a plurality of natural language processing techniques. The rule/pattern suppression model 402 includes a part of speech (POS) module 404. The part of speech module 404 is configured to suppress an invalid answer to a query based upon the invalid answer being a part of speech that is not expected as a valid answer to the query. In an example, if an expected answer to the query is a noun, but the (invalid) answer is a verb, the POS module 404 will suppress the (invalid) answer. The rule/pattern suppression model 402 also includes a dependency tree module 406. The dependency tree module 406 is configured to suppress invalid answers to a query by generating a dependency tree of the query and/or the invalid answer and analyzing the dependency tree. The rule/pattern suppression model 402 further includes a regex module 408. The regex module 408 is configured to suppress invalid answers to a query based upon regular expression matching. In an example, if an expected answer to a query is a number, the regex module 408 uses regular expression matching to suppress answers that do not include numbers.

The suppressor 330 further includes a normalizer 410. The normalizer 410 is configured to normalize potential answers generated by the initial fact generator 320 into a format supported by the knowledge graph 112 and/or the ontology 114. If a potential answer cannot be normalized into the format, the suppressor 330 suppresses the potential answer. In an example, if an answer to the query is supposed to be a date in a date format (e.g., Month-Date-Year), but the potential answer is an integer, the normalizer 410 cannot normalize the potential answer, and the suppressor 330 suppresses the potential answer. In another example, if the answer to the query is supposed to be a date in a first date format (e.g., Month-Date-Year), but the potential answer is in a second date format (e.g., Year-Month-Date), the normalizer 410 normalizes the potential answer to be in the first date format and the suppressor 330 does not suppress the potential answer.

The suppressor 330 includes an entity linker 412. The entity linker 412 is configured to compare an entity referenced in a passage (identified via the initial fact generator 320) to an entity referenced in a query generated by the query builder 318. The entity linker 412 determines that the entity referenced in the passage is different than or the same as the entity referenced in the query by searching the knowledge graph 112 for the entity. When a comparison performed by the entity linker 412 indicates that the entity referenced in the passage is different than the entity referenced in the query, the suppressor 330 suppresses a potential answer originating from the passage. When the comparison performed by the entity linker 412 indicates that the entity referenced in the passage is the same as the entity referenced in the query, the suppressor 330 does not suppress the potential answer originating from the passage.

The suppressor 330 further includes an inconsistency checker 414. The inconsistency checker 414 is configured to determine whether a fact generated by the fact extractor 316 is consistent with existing facts for the entity in the knowledge graph 112. When the generated fact is not consistent with an existing fact for the entity in the knowledge graph 112, the suppressor 330 suppresses the generated fact or the suppressor 330 removes the existing fact for the entity from the knowledge graph 112. In an example, the generated fact indicates that Person 1 was born on 09/18/90, but an existing fact in the knowledge graph 112 indicates that Person 1 died on 09/18/89. As a date of death cannot precede a date of birth, the generated fact is inconsistent and the suppressor 330 suppresses the generated fact.

The suppressor 330 further includes a deep learning suppression model 416. The deep learning suppression model 416 is configured to check if a generated fact (built by the fact extractor 316) is consistent with the passage from which the fact was built. According to embodiments, the deep learning suppression model 416 is a transformer-based machine learning model.

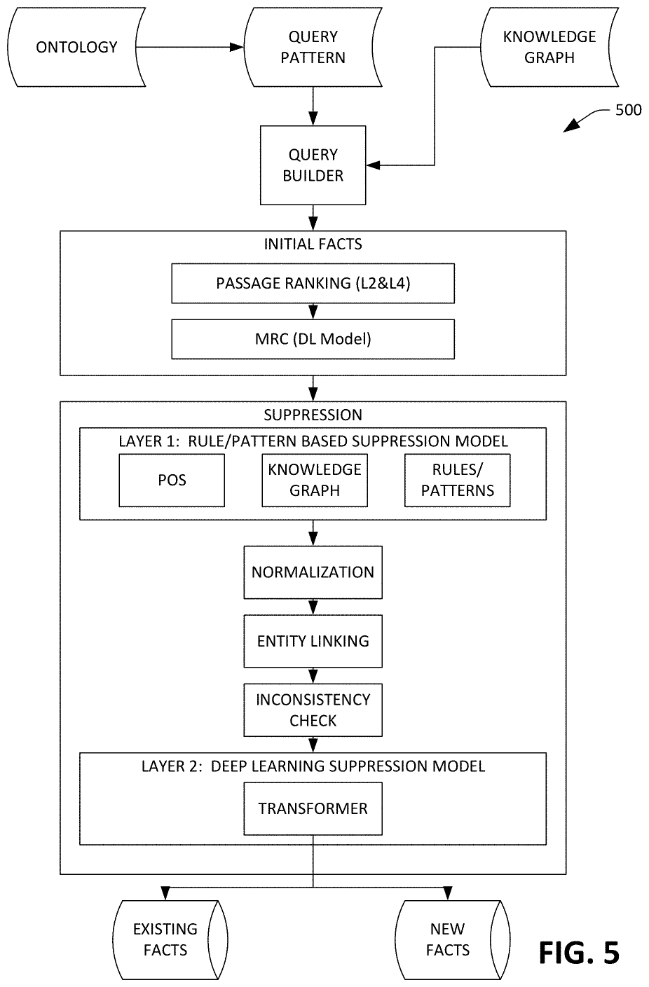

Turning now to FIG. 5, a high-level overview of an example process 500 of adding facts to a knowledge graph is illustrated. The process 500 may be performed by the computing system 300.

With reference now to FIGS. 3 and 4, operation of the computing system 300 is now set forth. The fact extractor 316 identifies that a fact for an entity is missing from the knowledge graph 112. In an example, the entity is Actor 1, the ontology 114 indicates that a date of birth of Actor 1 should be included in the knowledge graph 112, but the knowledge graph 112 does not currently include the date of birth of Actor 1.

The query builder 318 generates a query (e.g., “What is the date of birth of Actor 1?”) that references the entity based upon a query pattern (e.g., “What is the date of birth of <person>?”) in the query patterns 310 and the ontology 114, where the ontology 114 indicates that the knowledge graph 112 is to include a date of birth for an entity of type person. According to embodiments, the fact extractor 316 executes a search over the passages 314 based upon the query, where search results for the search include potentially relevant passages in the plurality of passages 314. According to other embodiments where there is a relatively small number of passages in the plurality of passage 314, each passage is potentially relevant and hence the fact extractor 316 proceeds to ranking each of the plurality of passages 314.

The recall ranker 324 ranks the potentially relevant passages based upon the query and criteria emphasizing recall and the fact extractor 316 identifies a first subset of the potentially relevant passages based upon the rankings assigned by the recall ranker 324. The precision ranker 326 ranks the potentially relevant passages based upon the query and criteria emphasizing precision and the fact extractor 316 identifies a second subset of the potentially relevant passages based upon the rankings assigned by the precision ranker 326, where a number of passages in the second subset is less than a number of passages in the first subset. According to embodiments, the precision ranker 326 re-ranks the first subset ranked by the recall ranker 324 and the fact extractor 316 identifies a highest ranked passage in the re-ranked first subset.

The MRC model 328 identifies (one or more) potential answers to the query in a passage that is identified by the recall ranker 324 and/or the precision ranker 326. In an example, the fact extractor 316 provides the query and the passage as input to the MRC model 328. The MRC model 328 identifies the potential answers to the query based upon learned weights of the MRC model 328, the query, and the passage. According to embodiments, a single passage (identified based upon rankings by the recall ranker 324 and/or the precision ranker 326) is provided as input to the MRC 328. According to embodiments, multiple passages (identified based upon rankings by the recall ranker 324 and/or the precision ranker 326) are provided as input to the MRC 328.

The suppressor 330 applies the rule/pattern suppression model 402 to suppress (e.g., remove) invalid answers in the potential answers. A potential answer may be invalid for several reasons including: (1) that potential answer does not correctly answer the query (e.g., “What is the date of birth of Actor 1”—“09/18/1969”, but Actor 1 was actually born on 09/18/1970), (2) the potential answer includes a (correct) answer but also includes additional information that is not relevant to the answer (e.g., “What is the date of birth of Actor 1?”—“brown eyes 09/18/1970”), or (3) a type of the potential answer does not match an expected type of an answer to the query (e.g., “What is the date of birth of Actor 1?”—“153.424”). In an example, the suppressor 330 utilizes the POS module 404, the dependency tree module 406, and/or the regex module 408 to suppress invalid answers (described above). The normalizer 410 normalizes the potential answers. When a potential answer cannot be normalized, the suppressor 330 suppresses the potential answer. The suppressor 330 utilizes the entity linker 412 to compare an entity in the passage to an entity referenced in the query. The suppressor 330 suppresses a potential answer (from the passage) as invalid when the entity in the passage does not match the entity referenced in the query.

The fact extractor 316 then generates a potential fact based upon a potential answer in the passage and the ontology 114. According to embodiments, the fact extractor 316 generates the potential fact in a subject-predicate-object triple form, where the subject is the entity (e.g., “Actor 1”), the object is the answer (e.g., “09/18/1970”), and the predicate is a relationship (e.g., “date of birth’) between subject and the object specified by the ontology 114.

The fact extractor 316 utilizes the inconsistency checker 414 to determine whether the fact generated by the fact extractor 316 is consistent with existing facts for the entity in the knowledge graph 112. When the fact is not consistent with an existing fact for the entity in the knowledge graph 112, the suppressor 330 suppresses the fact. Alternatively, the suppressor 330 may remove the existing fact for the entity from the knowledge graph 112.

As a final check, the fact extractor 316 provides the fact and the passage from which the fact was generated to the deep learning suppression model 416. The deep learning suppression model 416 outputs an indication as to whether the fact is consistent with the passage based upon the fact and the passage. When the deep learning suppression model 416 outputs an indication that the fact is not consistent with the passage, the fact is suppressed.

When the deep learning suppression model 416 outputs an indication that the fact is consistent with the passage, the fact extractor 316 adds the fact to the knowledge graph 112. In an example where the fact is an attribute of the entity, the fact extractor 316 (or the graph application 110) generates a node in the knowledge graph 112 representing the attribute (e.g., “09/18/1970”) and connects the node to a node representing the entity (e.g., “Actor 1”) via an edge, where the edge is assigned criteria based upon a relationship (e.g., “date of birth”) between the entity and the attribute, where the relationship is specified in the ontology 114. In an example where the fact is an attribute of the entity and a node for the attribute exists within the knowledge graph 112, but is marked as missing in the knowledge graph 112, the fact extractor 316 (or the graph application 110) associates a portion of the fact (e.g., the answer) with the node such that the node includes the answer. In an example where the fact is a second entity that exists in the knowledge graph 112, the fact extractor 316 (or the graph application 110) connects a node representing the entity to a node representing the second entity via an edge, where the edge is assigned criteria based upon a relationship between entity and the second entity, where the relationship is specified in the ontology 114 based upon respective types of the entity and the second entity. In an example where the node representing the second entity does not exist in the knowledge graph 112, the fact extractor 316 (or the graph application 110) generates a node for the second entity and connects the node representing the entity to the node representing the second entity via the edge. The fact is then available for querying by users. In an example, when the computing device 116 queries the knowledge graph 112 using a user query that references the entity, the fact is obtained from the knowledge graph 112 and presented by the computing device 116.

According to embodiments, the answer to the query is found in both a first passage in the plurality of passages 314 and a second passage in the plurality of passages 314. According to the embodiments, the fact extractor 316 applies the above-described processes to both the first passage and the second passage in order to identify a first instance of the answer and a second instance of the answer. According to the embodiments, the fact extractor 316 ensures that the first instance of the answer matches the second instance of the answer as an additional check that the answer is correct. According to the embodiments, the fact extractor 316 also generates a first instance of a fact (based upon the first instance of the answer) and a second instance of the fact (based upon the second instance of the answer) using the above-described processes. According to the embodiments, the fact extractor 316 ensures that the first instance of the fact matches the second instance of the fact as a further check that the fact is correct.

The fact extractor 316 may repeat the above-described processes using different queries that reference the entity in order to generate different facts for the entity and add the different facts to the knowledge graph 112. Furthermore, the fact extractor 316 may repeat the above-described processes using queries that reference different entities in order to generate facts for the different entities and add such facts to the knowledge graph 112.

While the above-described technologies have been described above as adding facts to the knowledge graph 112 that are missing from the knowledge graph 112, other possibilities are contemplated. According to embodiments, the above-described technologies are used to generate a fact and compare the fact to an existing fact in the knowledge graph 112. When the generated fact does not match the existing fact, the generated fact may replace the existing fact in the knowledge graph 112. In an example, the knowledge graph 112 includes an existing fact that indicates that a date of birth of Doctor 1 is 09/18/1990; however, the fact generated by the fact extractor application 316 indicates that Doctor 1 was born on 09/18/1970. In the example, the fact extractor application 316 changes the date of birth of Doctor 1 in the knowledge graph 112 from 09/18/1990 to 09/18/1970.

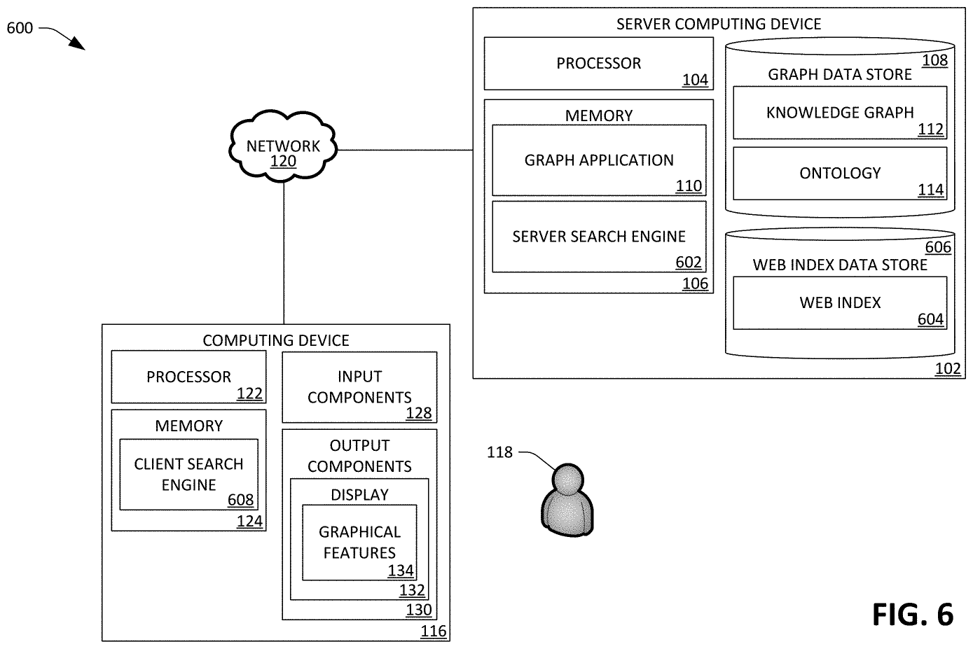

Referring now to FIG. 6, an example computing system 600 that facilitates delivering facts obtained from a knowledge graph as part of a search engine results page that is presented to a user is illustrated. The computing system 600 includes the server computing device 102 and its associated components (e.g., the graph application 110, the knowledge graph 112, etc.) described above in the description of FIG. 1. In an example, the computing system 300 has utilized the above-described processes to add a new fact to the knowledge graph 112 that was previously missing from the knowledge graph 112.

In the computing system 600, the memory 106 of the server computing device 102 further includes a server search engine 602. The server search engine 602 is configured to search a web index 604 stored in a web index data store 606 based upon a user query of the user 118 and to return search results based upon the user query, where the search results include at least one uniform resource locator (URL). According to embodiments, the server search engine 602 may be or include the graph application 110 or the graph application 110 may be or include the server search engine 602.

The computing system 600 also includes the computing device 116 and its associated components described above in the description of FIG. 1. In the computing system 600, the memory 124 of the computing device 116 includes a client search engine 608. The client search engine 608 is configured to receive a user query set forth by the user 118 via one or more of the input components and to transmit the user query to the graph application 110 and/or the server search engine 602. The client search engine 608 is further configured to receive search results from the server search engine 602 and/or the graph application 110 and present the search results to the user 118 (e.g., as part of the graphical features 134 presented on the display 132).

In operation, the client search engine 608 receives a user query from the user 118 that is set forth by the user 118 via the input components 128. The client search engine 608 transmits the user query over the network 120 to the server computing device 102. Upon receiving the user query, the server search engine 602 searches the web index 604 based upon the user query and obtains search results for the search. The search results include at least one URL.

The graph application 110 also searches the knowledge graph 112 based upon the user query. In an example, the graph application 110 identifies a node in the knowledge graph 112 that represents an entity identified in the user query. The graph application 110 walks the knowledge graph 112 from the node representing the entity to obtain facts about the entity. In an example, the graph application 110 obtains a fact about the entity that was added via the above-described processes. According to embodiments, the graph application 110 converts the user query into a format of the ontology 114 in order to search the knowledge graph 112.

The graph application 110 and/or the server search engine transmit search results for the search to the client search engine 608, where the search results include at least one URL (obtained from the web index 604) and at least one fact (obtained from the knowledge graph 112). The client search engine 608 presents the search results to the user 118 (e.g., as part of the graphical features 134 shown on the display 132).

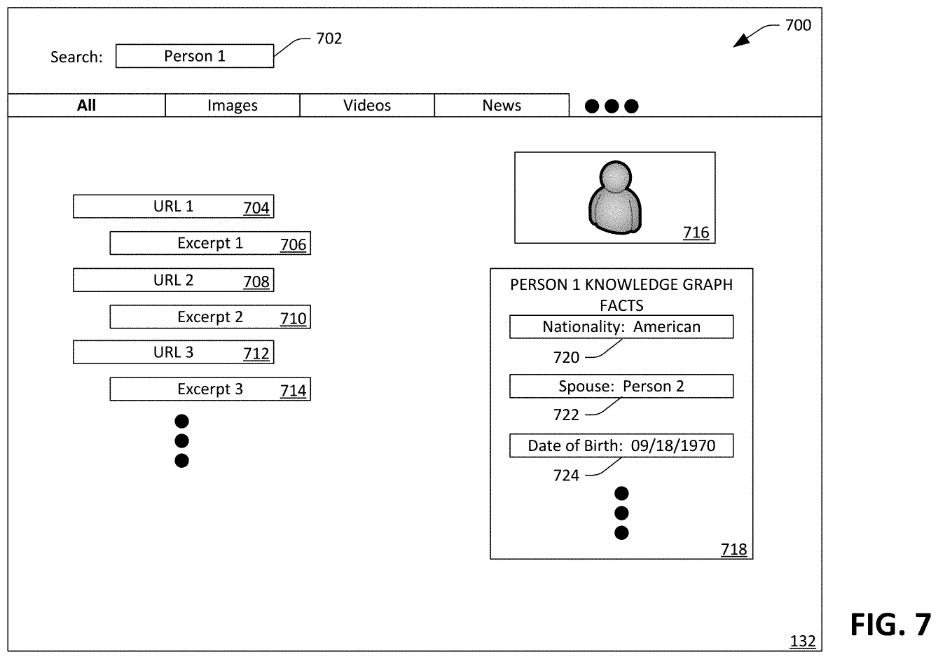

Turning now to FIG. 7, an example search engine results page 700 that is presented on the display 132 of the computing device 116 as part of the graphical features 134 is depicted. The search engine results page 700 may be received by the client search engine 608 from the server search engine 602 and/or the graph application 110. The search engine results page 700 includes a search field 702 that received the user query set forth by the user 118. In the example shown in FIG. 7, the user query is “Person 1”. The search results page 700 further includes a first URL 704 and a corresponding excerpt 706, a second URL 708 and a corresponding excerpt 710, and a third ULR 712 and a corresponding excerpt 714, where the first URL 704, the second URL 708, and the third URL 712 are obtained from the web index 604. The search results page 700 further includes an image 716 of Person 1. The search results page 700 also includes a section 718 that includes facts about Person 1 that have been obtained from the knowledge graph 112. The section 718 includes a first fact 720 (“Nationality: American”), a second fact 722 (“Spouse: Person 2”), and a third fact 724 (Date of Birth: 09/18/1986”). In an example, the third fact 724 was added to the knowledge graph 112 using the processes described above.

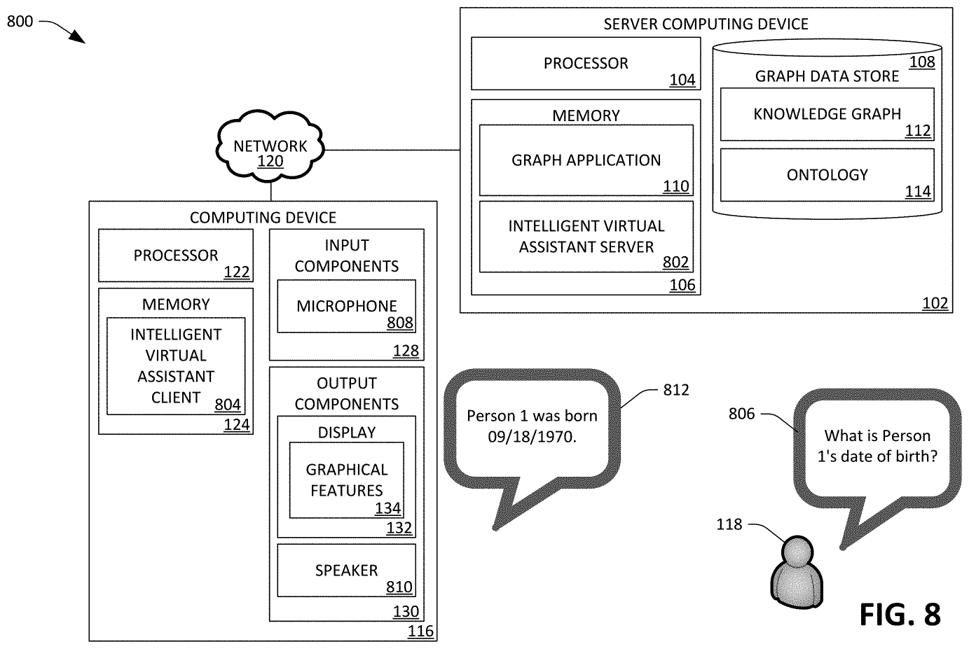

Referring now to FIG. 8, an example computing system 800 that facilitates delivering facts obtained from a knowledge graph via an intelligent virtual assistant is illustrated. The computing system 800 includes the server computing device 102 and its associated components (e.g., the graph application 110, the knowledge graph 112, etc.) described above in the description of FIG. 1. In an example, the computing system 300 has utilized the above-described processes to add a new fact to the knowledge graph 112 that was previously missing from the knowledge graph 112. The computing system 800 also includes the computing device 116 and its associated components described above in the description of FIG. 1.

In the computing system 800, the memory 106 of the server computing device 102 further includes an intelligent virtual assistant server 802 and the memory 124 of the computing device 116 includes an intelligent virtual assistant client 804. Together, the intelligent virtual assistant server 802 and the intelligent virtual assistant client 804 form an intelligent virtual assistant service that receives a user query from the user 118 and that presents an answer to the user query to the user 118. According to embodiments, the intelligent virtual service is Microsoft® Cortana®.

In operation, the user 118 utters an audible user query 806 (e.g., “What is Person 1's date of birth?”) that is captured by a microphone 808 of the computing device 116. The intelligent virtual assistant client 804 transmits the query (or data derived from the query) to the intelligent virtual assistant server 802. The intelligent virtual assistant server 802 and the graph application 110 communicate in order to retrieve a fact from the knowledge graph 112 that answers the user query. The intelligent virtual assistant server 802 transmits an answer that includes the fact to the intelligent virtual assistant client 804, whereupon the intelligent virtual assistant client 804 presents the answer to the user 118. In an example, the intelligent virtual assistant client 804 causes a speaker 810 to emit an audible answer 812 (“Person 1 was born on 09/18/1970”).

Although the knowledge graph 112 has been described above as being stored in the graph data store 108 of the server computing device 102 and the computing system 300, other possibilities are contemplated. In an example, the knowledge graph 112, the query logs 308, the query patterns 310, and/or the passages 314 are stored in a data store of the computing device 116 operated by the user 118. As such, the knowledge graph 112 may be queried locally without requiring communications over the network 120. Furthermore, facts may be added to the knowledge graph 112 using the above-described processes without requiring communications over the network 120.

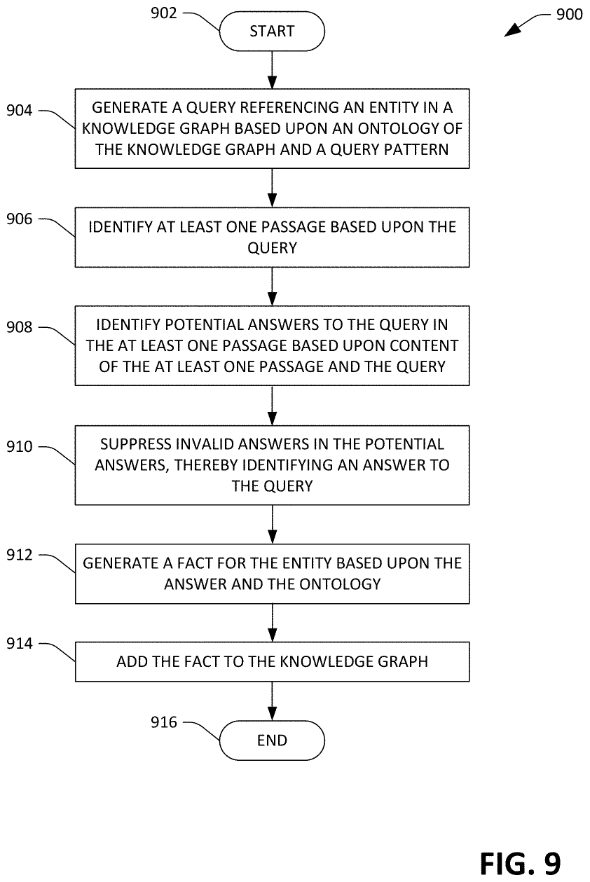

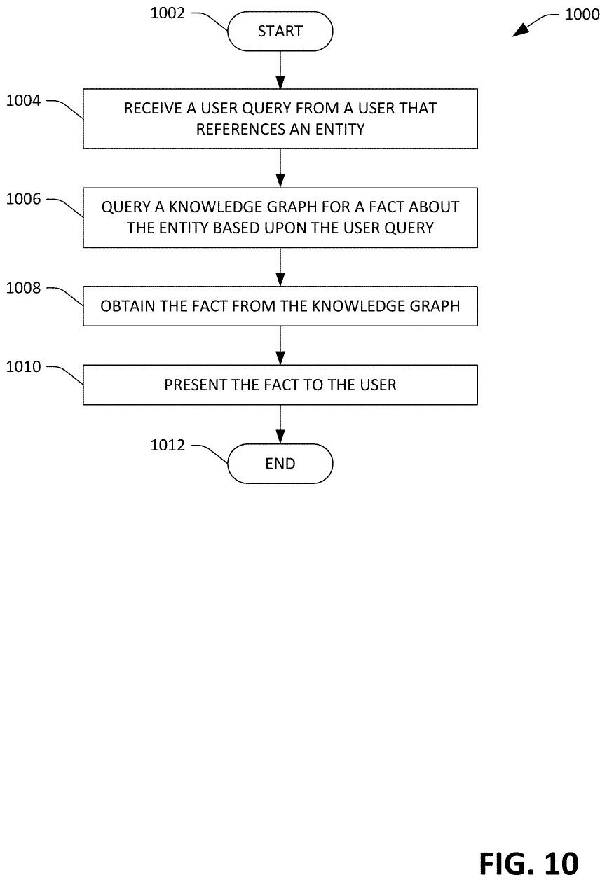

FIGS. 9 and 10 illustrate example methodologies relating to adding new facts to a knowledge graph. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 9, a methodology 900 performed by a computing system for adding facts to a knowledge graph is illustrated. The methodology 900 begins at 902, and at 904, the computing system generates a query that references an entity in a knowledge graph based upon an ontology of the knowledge graph and a query pattern. At 906, the computing system identifies at least one passage from amongst a plurality of passages stored in a passage repository based upon the query. At 908, the computing system identifies potential answers to the query in the at least one passage based upon content of the at least one passage and the query. At 910, the computing system suppresses invalid answers in the potential answers to the query, thereby identifying an answer to the query. At 912, the computing system generates a fact for the entity based upon the answer and the ontology. At 914, the computing system adds the fact to the knowledge graph, where the fact is linked to the entity in the knowledge graph. The fact is returned to a computing device of a user upon the computing system receiving a user query that references the entity from the computing device. The methodology 900 concludes at 916.

Turning now to FIG. 10, a methodology 1000 performed by a computing device operated by a user that facilitates presenting a newly added fact in a knowledge graph to the user is illustrated. The methodology 1000 begins at 1002, and at 1004, the computing device receives a user query from the user, where the user query references an entity. At 1004, the computing device queries a knowledge graph for a fact about the entity based upon the user query. The fact about the entity has been added to the knowledge graph by generating a query that references the entity based upon an ontology of the knowledge graph and a query pattern, identifying at least one passage from amongst a plurality of passages based upon the query and at least one ranking model, identifying potential answers to the query in the at least one passage based upon content of the at least one passage, the query, and an MRC model, suppressing invalid answers in the potential answers in order to identify an answer, and generating the fact based upon the answer and the ontology. At 1006, the computing device obtains the fact from the knowledge graph. At 1008, the computing device presents the fact to the user. The methodology 1000 concludes at 1010.

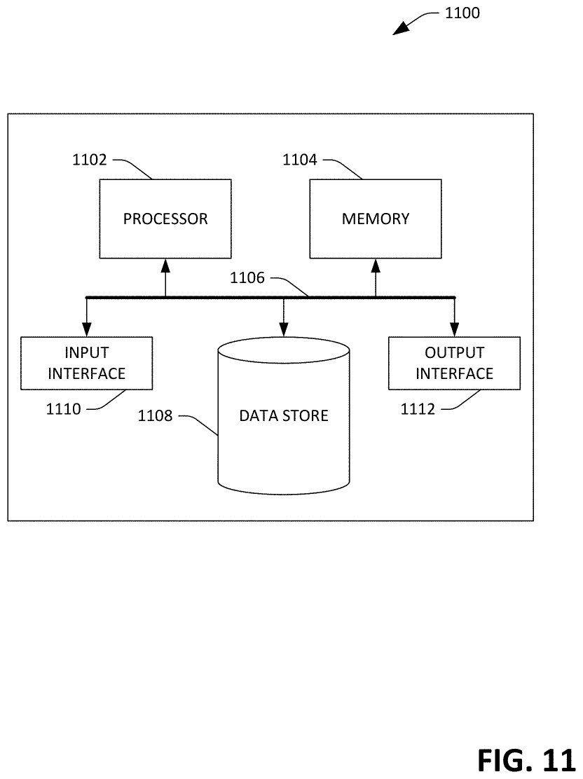

Referring now to FIG. 11, a high-level illustration of an example computing device 1100 that can be used in accordance with the systems and methodologies disclosed herein is illustrated. For instance, the computing device 1100 may be used in a system that adds a new fact to a knowledge graph. By way of another example, the computing device 1100 can be used in a system that presents facts in a knowledge graph to a user. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store knowledge graphs, ontologies, query logs, query patterns, computer-implemented models, web indices, etc.

The computing device 1100 additionally includes a data store 1108 that is accessible by the processor 1102 by way of the system bus 1106. The data store 1108 may include executable instructions, knowledge graphs, ontologies, query logs, query patterns, computer-implemented models, web indices, etc. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

It is contemplated that the external devices that communicate with the computing device 1100 via the input interface 1110 and the output interface 1112 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1100 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1100 may be a distributed system. Thus, for instance, several devices may be in communication by way of a network connection and may collectively perform tasks described as being performed by the computing device 1100.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. Such computer-readable storage media can include random-access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present disclosure relates to adding new facts to a knowledge graph and providing the new facts to users according to at least the examples provided in the section below:

(A1) In one aspect, some embodiments include a method (e.g., 900) performed by a processor (e.g., 302) of a computing system (e.g., 300). The method includes generating (e.g., 904) a query that references an entity in a knowledge graph (e.g., 112) based upon an ontology (e.g., 114) of the knowledge graph (e.g., 112) and a query pattern (e.g., 310). The method further includes identifying (e.g., 906) at least one passage from amongst a plurality of passages (e.g., 314) stored in a passage repository (e.g., 312) based upon the query. The method additionally includes identifying (e.g., 908) potential answers to the query in the at least one passage based upon content of the at least one passage and the query. The method also includes suppressing (e.g., 910) invalid answers in the potential answers to the query, thereby identifying an answer to the query. The method further includes generating (e.g., 912) a fact for the entity based upon the answer and the ontology. The method additionally includes adding (e.g., 914) the fact to the knowledge graph, where the fact is linked to the entity in the knowledge graph and where the fact is returned to a computing device (e.g., 116) of a user (e.g., 118) upon the computing system receiving a user query that references the entity from the computing device.

(A2) In some embodiments of the method of A1, the potential answers are identified based upon a machine reading comprehension model (e.g., 328) that takes the at least one passage and the query as input and that outputs the potential answers based upon the input.

(A3) In some embodiments of any of the methods of A1-A2, the answer is one of an attribute; or an identifier for a second entity, where the second entity is referenced in the knowledge graph.

(A4) In some embodiments of any of the methods of A1-A3, the plurality of passages include web pages that include unstructured text.

(A5) In some embodiments of any of the methods of A1-A4, the fact is based upon a type of the entity.

(B1) In another aspect, some embodiments include a computing system (e.g., 300) that includes a processor (e.g., 302) and memory (e.g., 304). The memory stores instructions that, when executed by the processor, cause the processor to perform any of the methods described herein (e.g., any of A1-A5).

(C1) In yet another aspect, some embodiments include a non-transitory computer-readable storage medium that includes instructions that, when executed by a processor (e.g., 302) of a computing system (e.g., 300), cause the processor to perform any of the methods described herein (e.g., any of A1-A5).

(D1) In another aspect, some embodiments include a method executed by a computing system (e.g., 300) that includes a processor (e.g., 302) and memory (e.g., 304). The method includes generating a query that references an entity based upon an ontology (e.g., 114) of a knowledge graph (e.g., 112) and a query pattern (e.g., 310). The method further includes identifying at least one passage from amongst a plurality of passages (e.g., 314) stored in a passage repository (e.g., 312) based upon the query. The method additionally includes identifying potential answers to the query in the at least one passage based upon content of the at least one passage and the query. The method also includes suppressing invalid answers in the potential answers to the query, thereby identifying an answer to the query. The method further includes generating a fact for the entity based upon the answer and the ontology. The method additionally includes adding the fact to the knowledge graph, where the fact is linked to the entity in the knowledge graph. The method also includes upon receiving a user query that references the entity from a computing device (e.g., 116), returning the fact to the computing device based upon the user query.

(D2) In some embodiments of the method of D1, the fact includes a unique identifier for the entity, a predicate that is based upon the query, and the answer.

(D3) In some embodiments of any of the methods of D1-D2, the knowledge graph includes nodes (e.g., 202, 204, 208, 212) and edges (e.g., 206, 210, 214, 216) connecting the nodes, where the nodes represent entities or attributes, and where the edges represent relationships between the entities or relationships between the entities and the attributes.

(D4) In some embodiments of any of the methods of D1-D3, the method further includes prior to generating the query, identifying that the fact for the entity is not present in the knowledge graph, where generating the query occurs responsive to identifying that the fact for the entity is not present in the knowledge graph.

(D5) In some embodiments of any of the methods of D1-D4, the at least one passage is identified based upon a recall passage ranking model (e.g., 324) that identifies a first subset of the plurality of passages based upon the query and a precision passage ranking model (e.g., 326) that identifies a second subset of the plurality of passages based upon the query, where a number of passages in the first subset is greater than a number of passages in the second subset.

(D6) In some embodiments of any of the methods of D1-D5, the query pattern is mined from query logs (e.g., 308) of a search engine.

(D7) In some embodiments of any of the methods of D1-D6, the method further includes searching a web index (e.g., 604) based upon the user query. The method additionally includes identifying uniform resource locators (URLs) based upon search results for the search, where a search engine results page (e.g., 700) that includes the URLs (e.g., 704, 708, 712) and the fact is returned to the computing device, and where the search results page is presented on a display (e.g., 132).

(D8) In some embodiments of any of the methods of D1-D7, the invalid answers are suppressed using at least one of regular expression matching (e.g., 408), part of speech analysis (e.g., 404), or dependency tree analysis (e.g., 406).

(D9) In some embodiments of any of the methods of D1-D8, the method further includes subsequent to identifying the potential answers to the query and prior to generating the fact, normalizing (e.g., 410) the potential answers to a format supported by the knowledge graph, where the answer is identified based upon the answer being successfully normalized to the format supported by the knowledge graph.

(D10) In some embodiments of any of the methods of D1-D9, the method further includes subsequent to generating the fact and prior to adding the fact to the knowledge graph, comparing the fact to a second fact for the entity in the knowledge graph, where the fact is added to the knowledge graph upon determining that the fact and the second fact are consistent.

(D11) In some embodiments of any of the methods of D1-D10, the method further includes subsequent to generating the fact and prior to adding the fact to the knowledge graph, providing the fact and the at least one passage as input to a deep learning model (e.g., 416), wherein the fact is added to the knowledge graph upon the deep learning model determining that the fact is consistent with the at least one passage.

(D12) In some embodiments of any of the methods of D1-D11, the at least one passage references the entity and the acts further include determining that the entity referenced in the at least one passage matches the entity referenced in the query based upon an entry in the knowledge graph for the entity.

(E1) In another aspect, some embodiments include a computing system (e.g., 300) including a processor (e.g., 302) and memory (e.g., 304). The memory stores instructions that, when executed by the processor, cause the processor to perform any of the methods described herein (e.g., any of D1-D12).

(F1) In yet another aspect, some embodiments include a non-transitory computer-readable storage medium that includes instructions that, when executed by a processor (e.g., 302) of a computing system (e.g., 300), cause the processor to perform any of the methods described herein (e.g., any of D1-D12).

(G1) In another aspect, some embodiments include a method performed by a computing system (e.g., 300) that includes a processor (e.g., 302). The method includes identifying that a fact is missing for an entity referenced in a knowledge graph (e.g., 112). The method further includes generating a query that references the entity based upon an ontology (e.g., 114) of the knowledge graph and a query pattern (e.g., 310). The method additionally includes identifying at least one passage from amongst a plurality of passages (e.g., 314) stored in a passage repository (e.g., 312) based upon the query. The method also includes identifying potential answers to the query in the at least one passage based upon content of the at least one passage and the query. The method further includes suppressing invalid answers in the potential answers to the query, thereby identifying an answer to the query. The method additionally includes generating the fact for the entity based upon the answer and the ontology. The method also includes adding the fact to the knowledge graph, where the fact is linked to the entity in the knowledge graph, and where the fact is returned to a computing device (e.g., 116) of a user (e.g., 118) upon receiving a user query that references the entity from the computing device.

(G2) In some embodiments of the method of G1, the knowledge graph is a domain-specific knowledge graph for an organization.

(G3) In some embodiments of any of the methods of G1-G2, a speaker (e.g., 810) of the computing device emits audible words that are indicative of the fact.

(H1) In another aspect, some embodiments include a computing system (e.g., 300) including a processor (e.g., 302) and memory (e.g., 304). The memory stores instructions that, when executed by the processor, cause the processor to perform any of the methods described herein (e.g., any of G1-G3).

(I1) In yet another aspect, some embodiments include a non-transitory computer-readable storage medium that includes instructions that, when executed by a processor (e.g., 302) of a computing system (e.g., 300), cause the processor to perform any of the methods described herein (e.g., any of G1-G3).

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system, comprising:
a processor; and
memory storing instructions that, when executed by the processor, cause the processor to perform acts comprising:
generating a query that references an entity based upon an ontology of a knowledge graph and a query pattern;
identifying at least one passage from amongst a plurality of passages stored in a passage repository based upon the query;
identifying potential answers to the query in the at least one passage based upon content of the at least one passage and the query;
suppressing invalid answers in the potential answers to the query, thereby identifying an answer to the query;
generating a fact for the entity based upon the answer and the ontology;
adding the fact to the knowledge graph, wherein the fact is linked to the entity in the knowledge graph; and
upon receiving a user query that references the entity from a computing device, returning the fact to the computing device based upon the user query.

2. The computing system of claim 1, wherein the fact comprises a unique identifier for the entity, a predicate that is based upon the query, and the answer.

3. The computing system of claim 1, wherein the knowledge graph comprises nodes and edges connecting the nodes, wherein the nodes represent entities or attributes, wherein the edges represent relationships between the entities or relationships between the entities and the attributes.

4. The computing system of claim 1, the acts further comprising:
prior to generating the query, identifying that the fact for the entity is not present in the knowledge graph, wherein generating the query occurs responsive to identifying that the fact for the entity is not present in the knowledge graph.

5. The computing system of claim 1, wherein the at least one passage is identified based upon:
a recall passage ranking model that identifies a first subset of the plurality of passages based upon the query; and
a precision passage ranking model that identifies a second subset of the plurality of passages based upon the query, wherein a number of passages in the first subset is greater than a number of passages in the second subset.

6. The computing system of claim 1, wherein the query pattern is mined from query logs of a search engine.

7. The computing system of claim 1, the acts further comprising:
searching a web index based upon the user query; and
identifying uniform resource locators (URLs) based upon search results for the search, wherein a search engine results page that includes the URLs and the fact is returned to the computing device, wherein the search results page is presented on a display.

8. The computing system of claim 1, wherein the invalid answers are suppressed using at least one of:
regular expression matching;
part of speech analysis; or
dependency tree analysis.

9. The computing system of claim 1, the acts further comprising:
subsequent to identifying the potential answers to the query and prior to generating the fact, normalizing the potential answers to a format supported by the knowledge graph, wherein the answer is identified based upon the answer being successfully normalized to the format supported by the knowledge graph.

10. The computing system of claim 1, the acts further comprising:
subsequent to generating the fact and prior to adding the fact to the knowledge graph, comparing the fact to a second fact for the entity in the knowledge graph, wherein the fact is added to the knowledge graph upon determining that the fact and the second fact are consistent.

11. The computing system of claim 1, the acts further comprising:
subsequent to generating the fact and prior to adding the fact to the knowledge graph, providing the fact and the at least one passage as input to a deep learning model, wherein the fact is added to the knowledge graph upon the deep learning model determining that the fact is consistent with the at least one passage.

12. The computing system of claim 1, wherein the at least one passage references the entity, the acts further comprising:
determining that the entity referenced in the at least one passage matches the entity referenced in the query based upon an entry in the knowledge graph for the entity.

13. A method performed by a processor of a computing system, comprising:
generating a query that references an entity in a knowledge graph based upon an ontology of the knowledge graph and a query pattern;
identifying at least one passage from amongst a plurality of passages stored in a passage repository based upon the query;
identifying potential answers to the query in the at least one passage based upon content of the at least one passage and the query;
suppressing invalid answers in the potential answers to the query, thereby identifying an answer to the query;
generating a fact for the entity based upon the answer and the ontology; and
adding the fact to the knowledge graph, wherein the fact is linked to the entity in the knowledge graph, wherein the fact is returned to a computing device of a user upon the computing system receiving a user query that references the entity from the computing device.

14. The method of claim 13, wherein the potential answers are identified based upon a machine reading comprehension model that takes the at least one passage and the query as input and that outputs the potential answers based upon the input.

15. The method of claim 13, wherein the answer is one of:
an attribute; or
an identifier for a second entity, wherein the second entity is referenced in the knowledge graph.

16. The method of claim 13, wherein the plurality of passages include web pages that comprise unstructured text.

17. The method of claim 13, wherein the fact is based upon a type of the entity.

18. A non-transitory computer-readable storage medium comprising instructions that, when executed by a processor of a computing system, cause the processor to perform acts comprising:
identifying that a fact is missing for an entity referenced in a knowledge graph;
generating a query that references the entity based upon an ontology of the knowledge graph and a query pattern;
identifying at least one passage from amongst a plurality of passages stored in a passage repository based upon the query;
identifying potential answers to the query in the at least one passage based upon content of the at least one passage and the query;
suppressing invalid answers in the potential answers to the query, thereby identifying an answer to the query;
generating the fact for the entity based upon the answer and the ontology; and
adding the fact to the knowledge graph, wherein the fact is linked to the entity in the knowledge graph, wherein the fact is returned to a computing device of a user upon receiving a user query that references the entity from the computing device.

19. The non-transitory computer-readable storage medium of claim 18, wherein the knowledge graph is a domain-specific knowledge graph for an organization.

20. The non-transitory computer-readable storage medium of claim 18, wherein a speaker of the computing device emits audible words that are indicative of the fact.
